(19) United States
(12) Patent Application Publication
(10) Pub. No.: US 2007/0005335 A1
(43) Pub. Date: Jan. 4, 2007

(54) Methods for protocol compatibility

(75) Inventor: Mats Almstrom, Stockholm (SE)

Correspondence Address: BROWDY AND NEIMARK, P.L.L.C.;624 NINTH STREET, NW, SUITE 300, WASHINGTON, DC, 20001-5303, US

(73) Assignee: CINNOBER FINANCIAL TECHNOLOGY AB, Stockholm (SE)

(21) Appl. No.: 11/433,648

(22) Filed: May 15, 2006

Related U.S. Application Data
(60) Provisional application No. 60/681,166, filed on May 16, 2005.

(51) Int. Cl. G06F 9/455

(52) U.S. Cl. 703/27

(57) ABSTRACT

The present invention relates to methods, a protocol, computer readable mediums and computer program products for establishing backward compatibility and forward compatibility of protocols used for communication between subsystems of an electronic trading system (10) having different software versions. The inventive method comprises the steps of: including a header containing generic packaging information including a table of protocol mismatch in each message for internal communication between the subsystems; and including content of each version in a separate sub-packet of the message, thereby allowing a receiving subsystem to unpack up to a certain version of the subsystem.

### FIELD OF THE INVENTION

The present invention relates to electronic trading systems for trading stocks, bonds, futures, options and other financial instruments as well betting and e-gaming, and in particular to methods, systems, computer readable mediums and computer program products for such systems.

### BACKGROUND OF THE INVENTION

During the last decade, almost all the world's exchanges and marketplaces have introduced electronic trading systems. These systems either replace the traditional trading floors or are used as complements to them. Today a large number of exchanges throughout the world utilize electronic trading to trade stocks, bonds, futures, options and other financial instruments. These electronic exchanges are generally includes three basic components, namely mainframe computers (host), communication servers, and the exchanges participants computers (client). The host constitutes, so to speak, the heart of the electronic trading system. The hosts operations includes, for example, order-matching, maintaining order books and positions or price information. Participants, e.g. traders, are capable of communicating with the host by means of high speed data lines, high speed communications servers and the Internet. Thus, the traders can participate in the market by means of the clients communicating with the host.

The different subsystems or computer nodes of such a trading system typically have software installed on them to control the operation of the nodes and their interaction with each other. It is essential that such distributed mission critical software systems can be upgraded stepwise (it is not a realistic approach to performing a “big-bang” upgrade of all subsystems of a trading system at one moment of practical reasons) and, thus, new “levels” are distributed in the network. Accordingly, some nodes will have the new version or level and other will have older versions and, therefore, new levels of software products frequently co-exist and communicate with older levels across such a computer network. An old version cannot in general accept or communicate with a new version if it contains significant changes, for example, in the way data is communicated to it and will generally reject or ignore the data. Due to the fact that the subsystems must be upgraded stepwise, the protocol used in the trading system for exchanging information between the subsystems must be backwards compatible as well as, at least to some extent, forwards compatible. This is illustrated in FIG. 2. A network, for example, a trading system, comprises subsystems 20-23, where subsystem 20 uses version 2, subsystem 21 uses version 2, subsystem 22 version 3, and subsystem 23 uses version 3. As indicated by A, subsystems 20 and 21 of the same version uses the same protocol. Moreover, a subsystem must be able, as indicated with B, to exchange information with subsystems of higher versions (i.e. newer versions), i.e. backwards compatibility. In addition, a subsystem must be able, as indicated by C, exchange information with subsystem of a lower version (i.e. older versions), i.e. forwards compatibility.

A number of techniques have been proposed to overcome this problem. In U.S. Pat. No. 6,754,717 such a technique is presented. The compatibility of the messages between different nodes is assured by means of internal communication between the different nodes. However, this solution requires an extensive internal communication, which may put a heavy load on the network. Furthermore, this solution may not solve the problem regarding forward compatibility.

Thus, there is need of an improved system and a method for establishing backward compatibility and forward compatibility of protocols used for communication between subsystems of an electronic trading system having different software versions.

### SUMMARY OF THE INVENTION

An object of the present invention is to provide an improved system and method for establishing backward compatibility and forward compatibility of protocols used for communication between subsystems of an electronic trading system having different software versions.

These and other objects are achieved according to the present invention by providing a system, a method, a computer program, and a computer readable medium having the features defined in the independent claims. Preferred embodiments are defined in the dependent claims.

According to a first aspect of the present invention, there is provided a method for establishing backward compatibility and forward compatibility of protocols used for communication between subsystems of an electronic trading system having different software versions. The method comprises the steps of: including a header containing generic packaging information including a table of protocol mismatch in each message for internal communication between the subsystems; and including content of each version in a separate sub-packet of the message, thereby allowing a receiving subsystem to unpack up to a certain version of the subsystem.

According to a second aspect of the present invention, there is provided a method for establishing backward compatibility and forward compatibility of protocols used for communication between subsystems of an electronic trading system having different software versions. The method comprises the steps of: sending a message created in accordance with the first aspect from a sending subsystem of the trading system to a receiving subsystem of the network; reading the header of the message at the receiving subsystem; unpacking the message up to the sub-packet containing the version of the receiving subsystem; and if the received messages version is higher than the receiving subsystems, checking a mismatch directive of the header.

According to a third aspect of the present invention, there is provided a protocol for establishing backward compatibility and forward compatibility for communication between subsystems of an electronic trading system having different software versions. The protocol comprises a header containing generic packaging information including a table of protocol mismatch in each message for internal communication between the subsystems; and a separate version sub-packet for each version of the subsystems.

According to a fourth aspect of the present invention, there is provided a computer program product, which when executed on a computer, performs steps in accordance with the method of the first aspect or the second aspect.

According to a further aspect of the present invention, there is provided a computer readable medium comprising instructions for bringing a computer to perform the method according to the first aspect or the second aspect.

Thus, the invention is based on the idea of including the version compatibility information into each message and, furthermore, to package the information regarding different versions in separate version packets included in the message, wherein each version packet contains one version.

As realized by the person skilled in the art, the methods of the present invention, as well as preferred embodiments thereof, are suitable to realize as a computer program or a computer readable medium.

These and other advantages with, and aspects of, the present invention will become apparent from the following detailed description and from the accompanying drawings.

### SHORT DESCRIPTION OF THE DRAWINGS

In the following description of an embodiment of the invention, reference will be made to the accompanying drawings of which:

FIG. 1 is a general view of an electronic trading system in which the present invention can be implemented;

FIG. 2 shows different subsystems having different software versions exchanging information; and

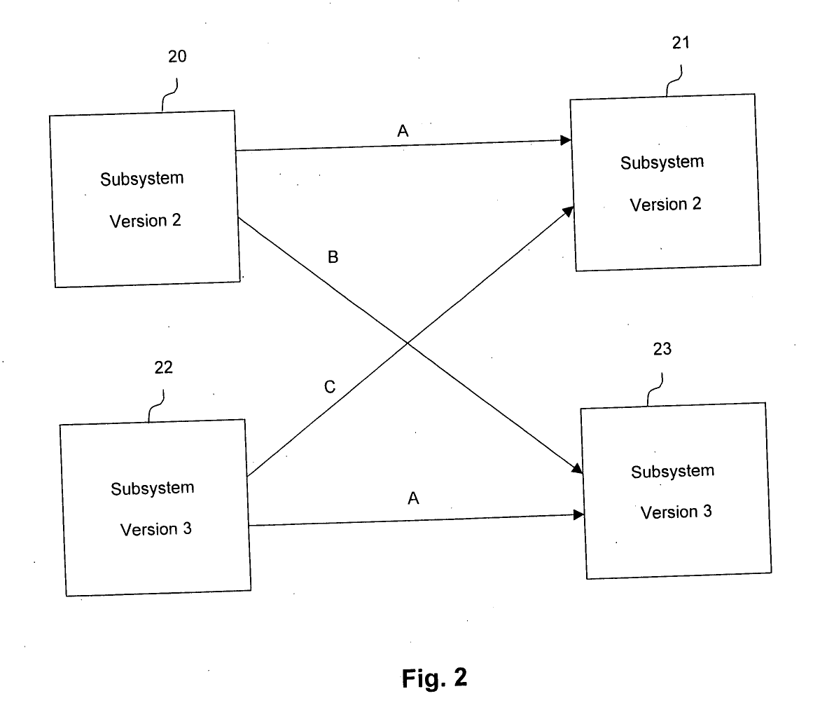

FIG. 3 shows a message packaging in accordance with the present invention.

### DETAILED DESCRIPTION OF THE INVENTION

In the following there will be discussed preferred embodiments of the methods and system for

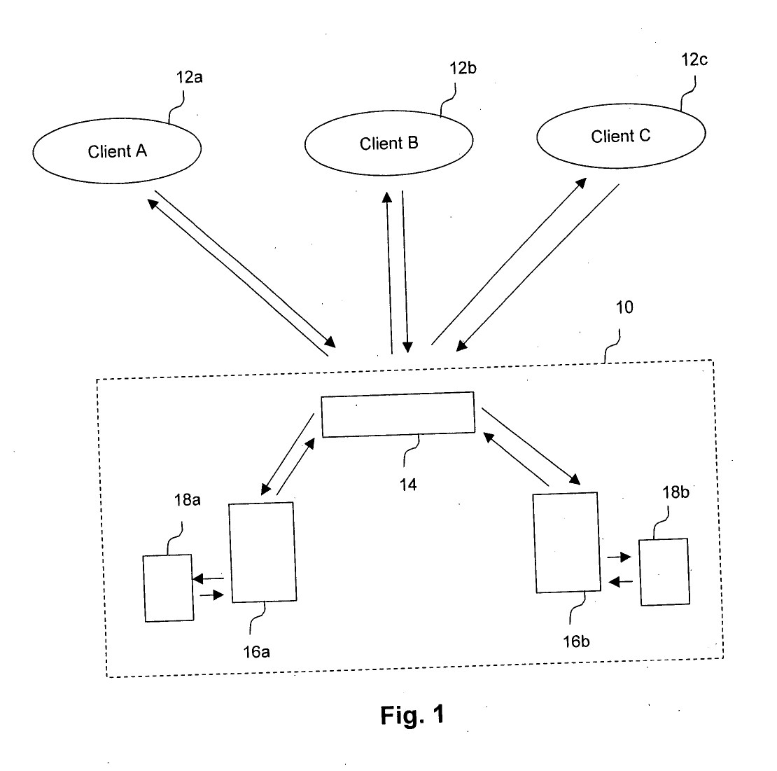

With reference first to FIG. 1, an electronic trading system in which the present invention can be implemented will be discussed. A number of clients, here indicated by client A 12a, client B 12b, and client C 12c, communicates with the trading or exchange system 10. Thus, traders can participate in the market by means of the clients 12a-12c communicating with the exchange system 10, i.e. the host. The clients 12a-12c may link to the system 10 via high speed data lines, high speed communication servers, or the Internet. High speed data lines establish direct connection between a client and the system. Connection can also be established between the client and the system by configuring high speed networks or communication servers at strategic access points in locations where traders physically are located. Internet is a third communication means enabling traders, using, for example, the clients 12a-12c, can communicate using, for example, high speed data lines connected to the Internet. Hence, trades are allowed to be located anywhere they can establish a connection to the Internet.

The system 10 comprises a gateway 14 arranged to receive incoming messages from the clients 12a-12c and distribute them to a server 16a acting as the primary node. In order to secure system availability, the exchange's system 0 often uses two servers placed in two geographically different spots interconnected via a network. One of the servers is considered being the primary server and the other consequently as the secondary. The system will be operational with only one server acting as primary, but will then, of course, not be redundant. The primary server 16a accepts incoming messages from transferred from the gateway 14, stores them in a storage means 18a in a log file. This storage means 18a may of course be physically separated from the system 10 and the server 16a. Furthermore, the primary server 16a replicates the messages to a secondary node or server 16b, which, in turn, stores in a storage means 18b in a log file, which storage means may be of course be physically separated from the system 10 and the secondary server 16b. The two servers 16a, 16b perform the same business logic procedure based on the incoming message. This results in the two servers being synchronized and having the same application state. If the primary server 16a fails for some reason, the secondary server 16b is accordingly able to take over and take the role as primary node and accept incoming messages. On the other hand, if the secondary server fails for some reason, the primary server just continuous to operate.

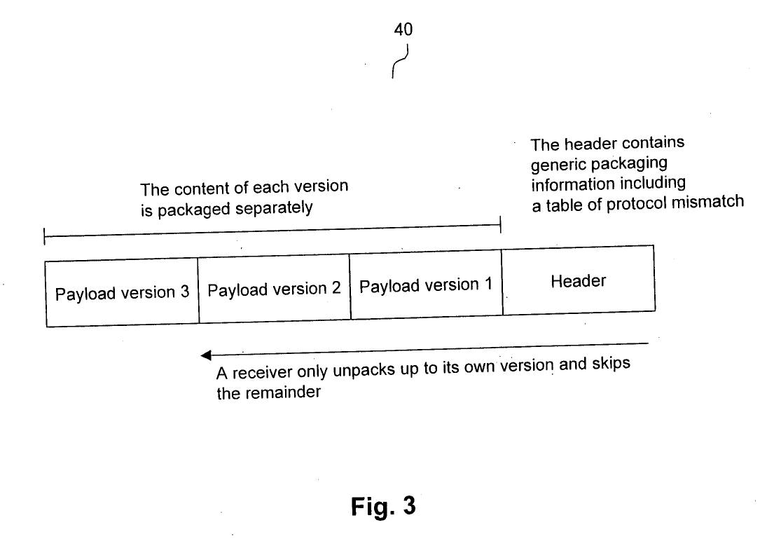

Turning now to FIG. 3, the message packaging in accordance with the present invention will be discussed. The invention is preferably realized in a trading system, for example, the system described with reference to FIG. 1. In order to achieve coexistence between multiple software versions, the packaging of the protocol data units (PDU) (the pieces of information to be exchanged between the different subsystems) is made in such a way that they could be understood by any receiving version. Moreover, for performance reasons, the PDU:s contain a minimum of meta information.

The exchange of PDU:s follows a simple pattern of encoding—transport—decoding. Every encoded outgoing message contains information about its protocol version and information regarding how subsystems of lower versions should handle this message. Furthermore, the content of each message is packaged in such a way that it can be unpackaged up to a certain version. This is achieved without space-demanding meta-information, only a simple packaging descriptor including space indication.

When a subsystem receives a PDU from some other subsystem, it does the following:
1. First, it reads the header part of the message
2. It them compares the received message's protocol version with its own version.

3. If the versions are the same or the received message's version is lower, it reads the complete message and processes it.
4. If the received message's version is higher than the subsystem's, it checks the mismatch directive that is included in the header. Three different kinds of directives exists:
   a. Safely ignore the information in the newer protocol versions and process the message
   b. Safely throw away the new message, as it has no significance
   c. Reject the message to the sender if the message is received synchronously, or signal abnormal state if the message is received asynchronously, i.e. there is no sender to reject to.

Thus, with reference to FIG. 3, each message 40 comprises a header and a separate packet containing information regarding each version being present in the network. In the embodiment shown in FIG. 3, three versions co-exist in the network.

Although specific embodiments have been shown and described herein for purposes of illustration and exemplification, it is understood by those of ordinary skill in the art that the specific embodiments shown and described may be substituted for a wide variety of alternative and/or equivalent implementations without departing from the scope of the invention. Those of ordinary skill in the art will readily appreciate that the present invention could be implemented in a wide variety of embodiments, including hardware and software implementations, or combinations thereof. This application is intended to cover any adaptations or variations of the preferred embodiments discussed herein. Consequently, the present invention is defined by the wording of the appended claims and equivalents thereof.

1. A method for establishing backward compatibility and forward compatibility of protocols used for communication between subsystems of an electronic trading system (10) having different software versions, characterized by the steps of:
including a header containing generic packaging information including a table of protocol mismatch in each message for internal communication between said subsystems; and
including content of each version in a separate sub-packet of said message, thereby allowing a receiving subsystem to unpack up to a certain version of said subsystem.

2. A method for establishing backward compatibility and forward compatibility of protocols used for communication between subsystems of an electronic trading system (10) having different software versions, characterized by the steps of:
sending a message created in accordance with claim 1 from a sending subsystem of said trading system (10) to a receiving subsystem of said network (10);
reading the header of said message at the receiving subsystem;
unpacking the message up to the sub-packet containing the version of the receiving subsystem; and
if the received messages version is higher than the receiving subsystems, checking a mismatch directive of said header.

3. A protocol for establishing backward compatibility and forward compatibility for communication between subsystems of an electronic trading system (10) having different software versions, characterized by
a header containing generic packaging information including a table of protocol mismatch in each message for internal communication between said subsystems; and
a separate version sub-packet for each version of said subsystems.

4. A computer program product, which when executed on a computer, performs steps in accordance with claim 1 or 2.

5. A computer readable medium comprising instructions for bringing a computer to perform the method according to claim 1 or 2.
